(19) United States
(12) Patent Application Publication
(10) Pub. No.: US 2020/0331791 A1
(43) Pub. Date: Oct. 22, 2020

(54) METHOD FOR CONTROLLING THE FORMATION OF METALLIC NANOPARTICLES IN GLASS AND PRODUCTS THEREOF

(71) Applicant: THE UNIVERSITY OF ADELAIDE, Adelaide, South Australia (AU)

(72) Inventors: Yunle WEI, Adelaide ,South Australia (AU); Heike EBENDORFF-HEIDEPRIEM, Dover Gardens ,South Australia (AU); Jiangbo ZHAO, Maylands ,South Australia (AU)

(21) Appl. No.: 16/755,628

(22) PCT Filed: Oct. 12, 2018
(86) PCT No.: PCT/AU2018/051115

§ 371 Date: Apr. 13, 2020

(30) Foreign Application Priority Data
Oct. 13, 2017 (AU) 2017904136

(51) Int. Cl. C03B 19/09; C03C 14/00

(52) U.S. Cl. CPC C03B 19/09; C03C 14/004; C03C 2214/30; C03C 2214/04; C03C 2214/08

(57) ABSTRACT

A method of forming metallic nanoparticles in glass is disclosed that creates evenly distributed metallic nanoparticles with desired size in any glass type.

Formation of a source of electrons trapped on the surface of the glass particles by crushing and grinding glass material into powder followed by heat treatment of the glass powder to neutralise metal ions doped in the glass by the trapped source of electrons, followed by the aggregation and growth of the metal into nanoparticles. The present method allows the homogeneous distribution of metal nanoparticles throughout the glass volume. The size and concentration of the metallic nanoparticles is controlled by the heat treatment temperature and duration as well as the amount of metal ions.

### FIELD OF THE INVENTION

The present invention relates to a method of producing metallic nanoparticles in glass material.

### BACKGROUND

The formation of metallic nanoparticles in glass, which is referred to as striking by glass manufacturers, involves the provision of “free” electrons to neutralize metal ions present in the glass. This is typically achieved through the use of polyvalent dopants, including the known toxins PbO and As₂O₃, post-annealing in reducing atmosphere (H₂), or high-energy irradiations (x-ray, gamma-ray). However, these conventional approaches have notoriously limited the success of creating metallic nanoparticles to silicate-based glasses or localized scale (sub micrometer).

In some emerging glass manufacturing technologies such as 3D printing, which uses glass powders, post-processing of the glass powder could induce undesired coloration of the resulting products due to the formation of reduced metal species (trace metal ions reduced by fracture-induced electrons).

### SUMMARY OF THE INVENTION

The method of the present invention is convenient and applicable to many different glass compositions. In particular, it is not necessarily limited to any particular oxide glass type but can also be extended to other glass materials.

For oxide glass, the size, concentration and distribution of the metal nanoparticles in the glass are able to be varied depending on specific requirements, providing the ability for the user to tune the colour and optical properties of the resulting glass.

A method of producing metallic nanoparticles in glass including the steps of:
a) preparing a glass precursor material including;
   heating a combination of at least one raw glass material with a metal base material to a first temperature to form a glass precursor melt;
   cooling the melt to provide the glass precursor material;
b) the glass precursor material then being ground to a predetermined particle size to form a ground glass precursor material;
c) heating the ground glass precursor material to a second temperature for a predetermined period of time to at least partially bind particles of the glass precursor material to one another.

In preference, at the second temperature the glass particles (containing metal in ionic/atomic dispersion) at least partially bind together.

In preference, the second temperature can be below, at or above the glass softening temperature defined as the temperature at which the viscosity of the glass material is approximately 10^{7.6} poise.

In preference, the second temperature is between about ±30% of the glass softening temperature of the ground glass precursor material.

In preference, the second temperature is between about ±20% of the glass softening temperature of the ground glass precursor material.

In preference, the second temperature is between about ±10% of the glass softening temperature of the ground glass precursor material.

In preference, the second temperature is between about ±5% of the glass softening temperature of the ground glass precursor material.

In preference, the raw glass material is at least one glass material selected from the group consisting of at least one glass network former or a combination of at least one glass network former and at least one glass network intermediate/modifier.

In preference, the glass network former is selected from at least one TeO₂, GeO₂, B₂O₃, SiO₂, P₂O₅, V₂O₅, Bi₂O₃, Sb₂O₃/Sb₂O₅, As₂O₃/As₂O₅ or combinations thereof.

In preference, the glass network intermediate/modifier is selected from at least one Li₂O, Na₂O, K₂O, Rb₂O, Cs₂O, BeO, MgO, CaO, SrO, BaO, ZnO, PbO/PbO₂, Al₂O₃, TiO₂, ZrO₂, Tho₂, CdO, Sc₂O₃, La₂O₃, Y₂O₃, SnO/Sno₂, In₂O₃, WO₃ or combinations thereof.

In preference, the raw glass material is at least one glass material selected from the group consisting of tellurite (TeO₂—ZnO—Na₂O [TZN]), germanate (GeO₂—Na₂O [GN]), borate (B₂O₃—Na₂O [BN]) phosphate (P₂O₅—Ag₂) [PAg]), borosilicate (commercial BK7) and silicate (SiO₂—Na₂O [SN], SiO₂—CaO—Na₂O [SCN], and commercial Gaffer Batch, K100 and F2).

In preference, the metal base material is a noble metal material.

In preference, the method step a) includes addition of at least one dopant material.

In preference, the metal base material is selected from at least one noble metal, metal alloy, metal compound (metal oxide, metal salt: metal chloride/sulfide/nitrite) or combinations thereof.

In preference, the at least one dopant material is selected from at least one noble metal, metal alloy, metal compound (metal oxide, metal salt: metal chloride/sulfide/nitrite) or combinations thereof.

In preference, the at least one noble metal is selected from the group consisting of copper, ruthenium, rhodium, palladium, silver, osmium, iridium, platinum and gold.

In preference, the noble metal is in a concentration of between 1 ppm and 2000 ppm.

In preference, the noble metal is in a concentration of between 5 ppm and 20 ppm.

In preference, the noble metal is in a concentration of between 8 ppm and 15 ppm.

In preference, the noble metal is in a concentration of 10 ppm.

In preference, the glass precursor material is ground to a predetermined particle size of between 0.01-1000 micrometre.

In preference, the glass precursor material is ground to a predetermined particle size of between 0.01-10 micrometre.

In preference, the predetermined period of time of heating the ground glass precursor material to the second temperature is between about 5 min and about 24 h.

In preference, the predetermined period of time is between about 10 min and about 6 hr.

In preference, the predetermined period of time is between about 10 min and about 2 hr.

In preference, the second temperature is the temperature at which the viscosity of the glass material is approximately 10^{7.6} poise.

In preference, the glass material TeO₂—ZnO—Na₂O (TZN) is in the ratio of 75:15:10 mol %.

In preference, the glass material GeO₂—Na₂O (GN) is in the ratio of 70:30 mol %.

In preference, the glass material B₂O₃—Na₂O (BN) is in the ratio of 70:30 mol %.

In preference, the glass material P₂O₅—Ag₂O (PAg) is in the ratio of 50:50 mol %.

In preference, the glass material SiO₂—CaO—Na₂O (SCN) is in the ratio of 70:10:20 mol %.

A glass article formed by the method of:
a) preparing a glass precursor material including;
   heating a combination of a metal base material with at least one raw glass material to a first temperature to form a glass precursor melt;
   cooling the glass precursor melt to provide the glass precursor material;
b) the glass precursor material then being ground to a predetermined particle size to form a ground glass precursor material;
c) heating the ground glass precursor material to a second temperature for a predetermined period of time to at least partially bind particles of the glass precursor material to one another.

A further embodiment of the invention resides in a method for controlling the formation of metallic nanoparticles in an oxide glass containing a metal compound where said method includes:
a. crushing the glass containing a noble metal base material or at least one dopant to a powder to produce a source of electrons on the glass powder surface;
b. reheating the glass powder at a temperature for a certain duration to at least partially bind particles of the glass precursor material to one another to allow the metal ions in the glass to be reduced by the source of electrons to form a metallic nanoparticle, or optionally adding an oxidant to remove at least some of the electrons to control or eliminate the formation of the metallic nanoparticle.

Yet a further embodiment of the present invention resides in a method for controlling the formation of metallic nanoparticles in an oxide glass where said method includes
a. forming a metal ion-doped precursor glass melt by incorporating a metal compound into the glass batch and melting at an elevated temperature;
b. Cooling the precursor glass melt to solidify the precursor glass
c. Crushing the solidified precursor glass in to a powder to produce a source of electrons on the glass powder surface;
d. Reheating the glass powder to a second temperature for a certain duration to at least partially bind particles of the glass precursor material to one another to allow the metal ions in the glass to be reduced by the source of electrons to form a metallic nanoparticle, or optionally adding an oxidant to remove at least some of the electrons to control or eliminate the formation of the metallic nanoparticle.

### BRIEF DESCRIPTION OF THE DRAWINGS

FIG. 1 is a schematic flow chart of the method of the present invention, showing Au doped TZN glass as an example;

FIG. 2 shows photographs and extinction spectra of (a) TZNAu1-4; (b) GNAg, GNAu, BNAu, PAg and SCNAu glasses; (c) Gaffer-BatchAu, Gaffer-BatchAuAg, K100Au, BK7Au and F2Au glasses;

FIG. 3(a) shows scanning electron microscope image of Au nanoparticles in TZNAul and 3(b) elemental analysis data;

FIG. 4 is a schematic diagram showing the two main methods associated with the invention;

FIG. 5(a) shows extinction spectra of reheated samples using glass powders of small grain size, medium grain size, and large grain size;

FIG. 5(b) shows optical microscope images of glass powder of small grain size, middle grain size and large grain size.

### DETAILED DESCRIPTION OF THE INVENTION

All glasses in the following examples were fabricated using tellurite (TZN), germanate (GN), borate (BN), phosphate (PAg) and silicate (SN, SCN, and commercial Gaffer Batch, K100, BK7 and F2) glass with composition (in mol %) 75TeO₂-15ZnO-10Na₂O (TZN), 70GeO₂-30Na₂O (GN), 70B₂O₃-30Na₂O (BN) 50P₂O₅-50Ag₂O (PAg), 70SiO₂-30Na₂O (SN), 70SiO₂-10CaO-20Na₂O (SCN), and commercial glass products from Gaffer Glass (Gaffer-Batch), Kugler glass (K100), Schott (BK7 and F2). Commercially sourced raw materials were used, including TeO₂, GeO₂, B₂O₃, (NH₄)HPO₄, SiO₂, ZnO, Na₂CO₃, AgNO₃ and commercial Gaffer-Batch, K100, BK7 and F2 powder. Recycled glass material may also be used in combination with other raw glass material.

Gaffer Batch material was commercial sourced from JM & KE van Domburgh trading as Artisand and has the following composition:

Section 3 - COMPOSITION/INFORMATION ON INGREDIENTS

| NAME | CAS RN | % |
|---|---|---|
| silica crystalline - quartz | 14808-60-7 | 30-60 |
| sodium carbonate | 497-19-8 | 10-30 |
| calcium carbonate | 471-34-1 | 1-10 |
| sodium borate anhydrous | 1330-43-4 | 1-10 |
| spodumene | 1302-37-0 | 1-10 |
| potassium carbonate | 584-08-7 | 1-10 |
| sodium nitrate | 7631-99-4 | 1-10 |
| zinc oxide | 1314-13-2 | 1-10 |
| antimony trioxide | 1309-64-4 | <1 |

K100 was commercially sourced from SPEZIALGLASHUTTE KUGLER COLORS GmbH Reiftragerweg 29, 87600 Kaufbeuren-Neugablonz, Germany

BK7 and F2 were sourced from Schott Australia Pty Ltd.

The method of the present invention is based on a three step process:

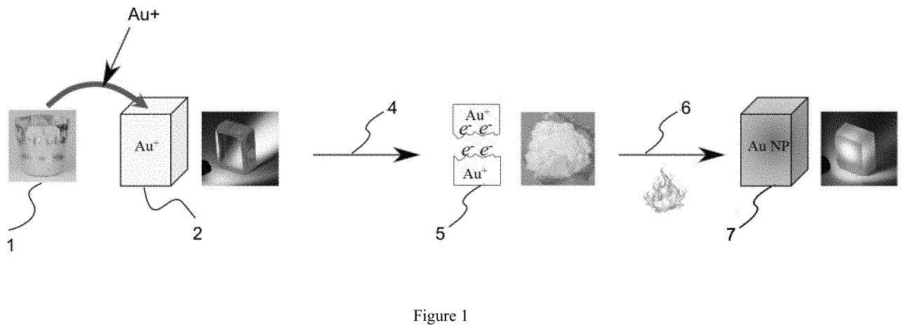

FIG. 1 shows a general overview of the process where glass precursor material 1 is heated with a metal doping material (Au in this example) to form a precursor glass material 2, which in this example is Au doped TZN glass. The Au doped TZN glass is subsequently ground 4 in a mortar to provide a fine glass powder 5 in which electrons are formed on the surface of the fine glass powder. The fine glass powder 5 is then heated again 6 to provide the Au nanoparticles in the glass material 7.

1. Preparation of Glass Precursor Material.

The glass material 10 is melted together with predetermined amount of HAuCl₄ or AgNO₃ or other metal compounds 15 in an alumina crucible 20 at high temperature T1 (first temperature), to form a glass melt 25, which applies for Au/Ag doped GN, BN and SCN, PAg and commercial Gaffer-Batch, K100, BK7 and F2 glass. Colourless noble metal ions doped precursor glass (colourless) was then obtained by quenching or cooling the high temperature glass melt 25 into a mould to provide the cooled glass precursor material 30. Alternatively, the metal ions, such as for example noble metal ions 55 from a gold crucible (the source of noble metal material), are introduced into the glass 50 by firstly melting the glass raw materials 50 in a gold crucible 60, at high temperature T1 (first temperature), to form a glass melt 65 which applies for Au doped TZN glass with the Au concentration controlled by the melting temperature/time. Colourless noble metal ions doped precursor glass (colourless) was then obtained by quenching or cooling the high temperature glass melt 65 into a mould to provide the cooled glass precursor material 70.

2. Introducing a Source of Electrons (Reducing Agent) for the Reduction of Noble Metal Ions

The glass precursor material 30 or 70 is then ground by mechanical action, which can be carried out with a mortar and pestle to provide a substantially uniform fine glass powder (micron size particles 81) to provide a ground glass precursor material 80. The size of the particles 81 in the fine glass precursor material powder 80 is predetermined by the user, smaller sized particles have shown to yield more consistent results than larger particles.

The action of the grinding action on the precursor glass material in a mortar made from agate creates electrons 82 on the surface or near surface of the particles 81 of the ground glass precursor material 80. In this process, the chemical bonds that connect the elements which build up the precursor glass material are broken and results in the formation of electrons 83 and metal ions/atoms 83 trapped at surface or near surface defects on the ground precursor glass material 80.

3. Reduction of Noble Metal Ions and Formation of Noble Metal Nanoparticles

The ground precursor glass powder material 80 is then heated to a second temperature T2 to at least partially bind the particles 81 of the glass precursor material to one another to form the glass material 90 with the glass particles 91 having metal nanoparticles 92.

During this T2 heating step the trapped electrons in the glass material 80 reduce the noble metal ions to atoms that then nucleate and grow into noble metal nanoparticles. The metal nanoparticles give the glass certain colours originating from the surface plasmon resonance (SPR) of the noble metal nanoparticles (absorption and scattering of light at certain wavelengths), which depends on the type, concentration and size of the nanoparticles as well as the refractive index of the glass (type of glass).

The concentration and size of the metal nanoparticles 92 in the glass depends on the concentration of the introduced noble metal ions as well as the reheating temperature and time.

If the formation of metallic nanoparticles is undesired upon heat-treatment of the powder, the neutralization and growth of nanoparticles can be prevented by eliminating the electrons on the surface of the glass particles by using oxidants.

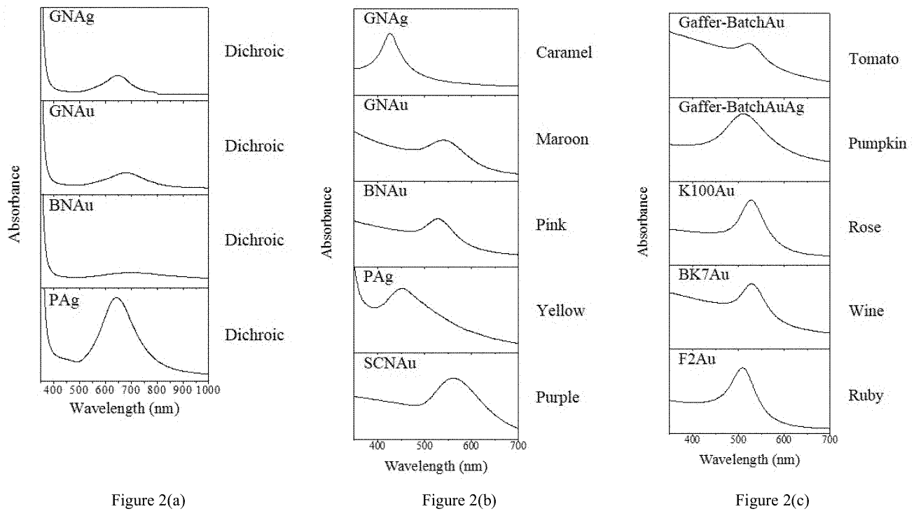

In the examples below TZN glass is shown as the major illustration system, with further examples of GN, BN, SN, SCN, PAg and commercial Gaffer-Batch, K100, BK7 and F2 glass. The concentration of introduced noble metal ions, glass melting temperature/time, and reheating temperature/time are given in the table blow. Extinction spectra of the formed colored glasses as well as their corresponding colour are shown in FIG. 2.

Extinction spectra of (a) TZNAu1-4; (b-c) GNAg, GNAu, BNAu, PAg, SCNAu, Gaffer-BatchAu, Gaffer-BatchAuAg, K100Au, BK7Au and F2Au glasses are shown in FIG. 2(a)-(c). We observed that TZNAu1-4 illuminated under tungsten light (white) shows dichroic effect (transmission of blue colour at the back of glasses while reflection of orange colour at the front surface of glasses). Dichroic effect of TZN Au glass results from Au nanoparticles larger than 50 nm (the average sizes of Au nanoparticles in TZNAu1-4 glasses all exceed 60 nm) so that light absorption and scattering are both prominent. The observed colour produced in GNAg, GNAu, BNAu, PAg, SCN, Au Gaffer-BatchAu, Gaffer-BatchAuAg, K100Au, BK7Au and F2Au glasses are mainly due to light absorption by Ag/Au/AuAg nanoparticles of sizes smaller than 50 nm.

| | | Melting | Metal ions/ | Reheating | |
|---|---|---|---|---|---|
| | | temperature | concentration | temperature | |
| Glass name | Glass type | and time T1 | (ppm weight ratio) | and time T2 | Glass color |
| TZNAu1 | TZN | 750° C., 1 h | Au (Au crucible), | 540° C., 10 min | Dichroic |
| | | | 10 ppm_{w} | | (blue in |
| | | | | | transmission |
| | | | | | and orange in |
| | | | | | reflection) |
| TZNAu2 | TZN | 750° C., 1 h | Au (Au crucible), | 560° C., 10 min | Dichroic |
| | | | 10 ppm_{w} | | (blue in |
| | | | | | transmission |
| | | | | | and orange in |
| | | | | | reflection) |
| TZNAu3 | TZN | 750° C., 1 h | Au (Au crucible), | 540° C., 30 min | Dichroic |
| | | | 10 ppm_{w} | | (blue in |
| | | | | | transmission |
| | | | | | and orange in |
| | | | | | reflection) |
| TZNAu4 | TZN | 800° C., 1 h | Au (Au crucible), | 540° C., 20 min | Dichroic |
| | | | 30 ppm_{w} | | (blue in |
| | | | | | transmission |
| | | | | | and orange in |
| | | | | | reflection) |
| GNAg | GN | 1250° C., 3 h | Ag (AgNO₃), | 600° C., 2 h | Caramel |
| | | | 1000 ppm_{w} | | |
| BNAu | BN | 1100° C., 3 h | Au (HAuCl₄), | 550° C., 2 h | Pink |
| | | | 5 ppm_{w} | | |
| GNAu | GN | 1250° C., 3 h | Au (HAuCl₄), | 600° C., 2 h | Maroon |
| | | | 50 ppm_{w} | | |
| BNAu | BN | 1100° C., 3 h | Au (HAuCl₄), | 550° C., 2 h | Pink |
| | | | 5 ppm_{w} | | |
| PAg | PAg | 600° C., 0.5 h | Ag (AgNO3), | 300° C., 2 h | Yellow |
| | | | 50 mol % | | |
| SCNAu | SCN | 1400° C., 2 h | Au (HAuCl₄), | 750° C., 10 h | Purple |
| | | | 200 ppm_{w} | | |
| Gaffer- | Gaffer- | 1400° C., 2 h | Au (HAuCl₄), | 750° C., 2 h | Tomato |
| BatchAu | Batch | | 50 ppm_{w} | | |
| Gaffer- | Gaffer- | 1400° C., 2 h | Au (HAuCl₄), | 900° C., 10 h | Pumpkin |
| BatchAuAg | Batch | | 50 ppm_{w} | | |
| | | | Ag (AgNO₃), | | |
| | | | 400 ppm_{w} | | |
| K100Au | K100 | 1400° C., 2 h | Au (HAuCl₄), | 650° C., 2 h | Rose |
| | | | 400 ppm_{w} | | |
| BK7Au | BK7 | 1400° C., 2 h | Au (HAuCl₄), | 800° C., 2 h | Wine |
| | | | 200 ppm_{w} | | |
| F2Au | F2 | 1400° C., 2 h | Au (HAuCl₄), | 750° C., 2 h | Ruby |
| | | | 200 ppm_{w} | | |
| BNAu | BN | 1100° C., 3 h | Au (HAuCl₄), | 550° C., 2 h | Pink |
| | | | 5 ppm_{w} | | |

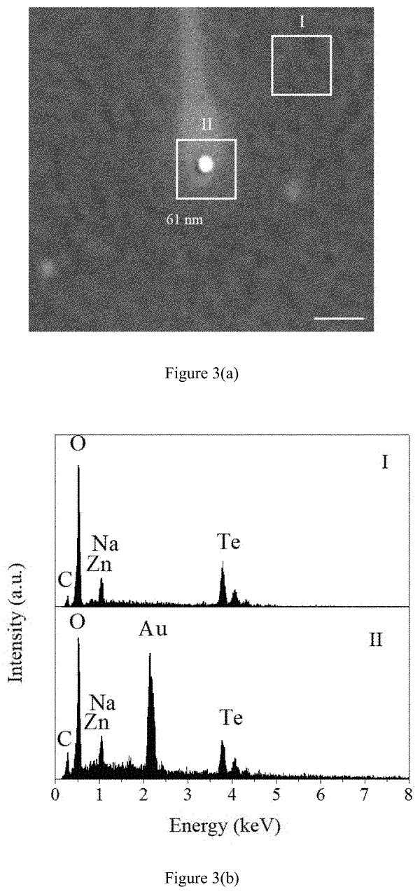

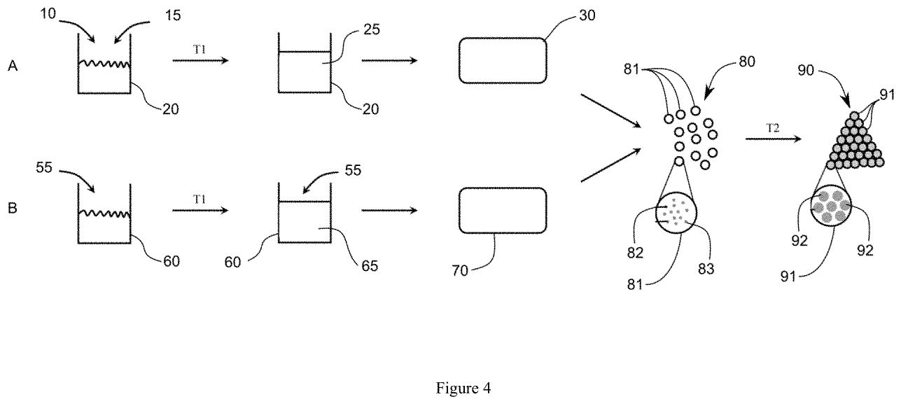

As shown in FIG. 3 (a) scanning electron microscope (SEM) image of Au nanoparticles (Au NP) in TZNAu1 with size determined to be 61 nm; 3(b) elemental analysis of the grey background (glass matrix) showing mainly Te, Zn and Na and O signals, and white Au NP showing intense Au signal

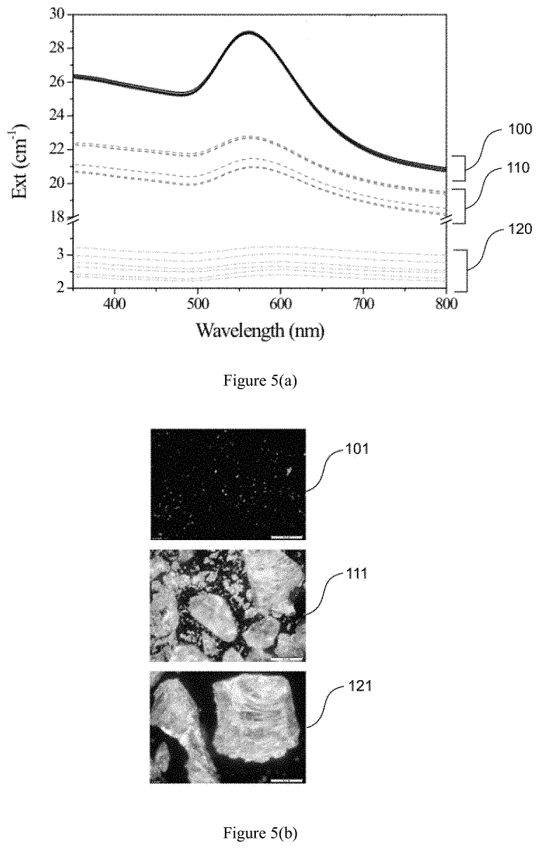

As shown in FIG. 5(a) various extinction spectra of reheated samples using glass powders of small grain size 100 (solid lines), medium grain size 110 (dashed lines), and large grain size 120 (dash dot lines). Extinction spectra at six different location on each sample are provided to show the homogeneity of each sample. FIG. 5(b) are optical microscope images of glass powder of small grain size 101 (top), middle grain size 111 (middle) and large grain size 121 (large). The sample made using glass powder of small grain size is homogeneous via naked eye and extinction spectra, while the homogeneity of color and extinction spectra become increasingly worse with increasing the grain size of glass powder. Also, a decrease and redshift of the SPR peak intensity and position is observed with the increase of the glass particle grain size, which indicates the formation of less Au NPs with larger in size

This method of the present invention provides an environmentally friendly way in which to introduce or form metal nanoparticles in glass material without the need to use toxic dopants such as PbO, As₂O₃, etc. It is safe, energy efficient and cost efficient, without the need to use reducing gas and relevant equipment, or high energy irradiation devices. The preparation method is scalable and easy to be implemented for mass production.

This method also provides a way of preventing the undesired coloration of the glass produced via glass powder based manufacturing techniques.

1. A method of producing nanoparticles in glass including the steps of:
a) preparing a glass precursor material including;
heating a combination of at least one raw glass material with a metal base material to a first temperature to form a glass precursor melt;
cooling the melt to provide the glass precursor material;
b) the glass precursor material then being ground to a predetermined particle size to form a ground glass precursor material;
c) heating the ground glass precursor material to a second temperature for a predetermined period of time to at least partially bind particles of the glass precursor material to one another.

2. The method of claim 1, wherein the at least one raw glass material is at least one glass material selected from the group consisting of tellurite (TZN), germanate (GN), borate (BN), phosphate (PAg), borosilicate (commercial BK7) and silicate (SN, SCN, and commercial Gaffer Batch, K100 and F2) glass.

3. The method of claim 2, wherein the at least one raw glass material is at least one raw glass material selected from the group consisting of TeO₂—ZnO—Na₂O (TZN), GeO₂—Na₂O (GN), B₂O₃—Na₂O (BN), P₂O₅—Ag₂O (PAg), SiO₂—Na₂O (SN), SCN (SiO₂—CaO—Na₂O) and of commercial glass products from Gaffer Glass (Gaffer), Kugler glass (K100), Schott (BK7 and F2).

4. The method of claim 1, wherein the at least one raw glass material is a combination of at least two glass materials.

5. The method of claim 1, wherein the nanoparticles are metallic nanoparticles.

6. The method of claim 1, wherein the metal base material is selected from at least one noble metal, metal alloy, metal compound (metal oxide, metal salt: metal chloride/sulfide/nitrite) or combinations thereof.

7. The method of claim 6, wherein the at least one noble metal is selected from the group consisting of ruthenium, rhodium, palladium, silver, osmium, iridium, platinum and gold.

8. The method of claim 1, wherein the second temperature is a temperature at which the viscosity of the glass material is approximately 10^{7.6} poise.

9. The method of claim 6, wherein the noble metal is in a concentration of between 1 ppm and 2000 ppm.

10. The method of claim 9, wherein the noble metal is in a concentration of between 5 ppm and 20 ppm.

11. (canceled)

12. (canceled)

13. The method of claim 9, wherein the noble metal is in a concentration of between 8 ppm and 15 ppm.

14. The method of claim 13, wherein the noble metal is in a concentration of 10 ppm.

15. The method of claim 1, wherein the glass precursor material is ground to a predetermined particle size of between 0.01-1000 micrometres.

16. The method of claim 15, wherein the glass precursor material is ground to a predetermined particle size of between 0.01-10 micrometres.

17. The method of claim 1, wherein the predetermined period of time of heating the ground glass precursor material to the second temperature is between about 5 minutes and about 24 hours.

18. The method of claim 1, wherein the predetermined period of time of heating the ground glass precursor material to the second temperature is between about 10 minutes and about 6 hours.

19. The method of claim 1, wherein the predetermined period of time of heating the ground glass precursor material to the second temperature is between about 10 minutes and about 2 hours.

20. The method of claim 1 where the glass precursor material is ground in a mortar.

21. The method of claim 20, wherein the mortar is a gold crucible (for TZN) or a alumina crucible for (BN, GN, SCN, PAg, and commercial Gaffer Batch, K100, BK7 and F2).

22. A glass product containing metallic nanoparticles produced by the method of claim 1.
